(19) United States
(12) Patent Application Publication
(10) Pub. No.: US 2023/0271526 A1
(43) Pub. Date: Aug. 31, 2023

(54) Roadway Charging System for Electric-Powered Vehicles and Method of Use

(71) Applicant: Harry Levy, New York, NY (US)

(72) Inventor: Harry Levy, New York, NY (US)

(21) Appl. No.: 18/175,388

(22) Filed: Feb. 27, 2023

Related U.S. Application Data
(60) Provisional application No. 63/268,674, filed on Feb. 28, 2022.

(51) Int. Cl. B60L 53/66; B60L 53/14; B60L 53/35; B60L 53/36

(52) U.S. Cl. CPC B60L 53/66; B60L 53/14; B60L 53/35; B60L 53/36

(57) ABSTRACT

A vehicle charging system with an elongated conductor that extends above or on top of the ground along a section of the roadway. An electric vehicle includes a conductor or conductive material that extends from the electric vehicle, toward the elongated conductor, or wirelessly connects to the conductor. The method of use of the charging system involves the steps of: (1) communication between the wireless charging system and the electric vehicle, where the electric vehicle provides identification information to the wireless charging system, (2) the electric vehicle and the charging system arrange for a charging session to commence, (3) the electric vehicle approaches the charging system, (4) the charging system acknowledges and activates the charging session, (5) the charging system provides electric charge to the electric vehicle without direct contact, and (5) the charging session is terminated.

### PRIORITY

This application claims domestic benefit from pending provisional patent application No. 63/268,674, filed on Feb. 28, 2022, and incorporated by reference.

### FIELD OF INVENTION

The invention is in the field of electric vehicle charging systems, in particular charging systems for use while the vehicle is in motion.

### BACKGROUND

Electric-powered vehicles are an environmentally friendly alternative to traditional gasoline powered vehicles, generating less pollution. While electric-powered vehicles are gaining in popularity, one obstacle to widespread acceptance is a difference in time between charging the electric-powered vehicle as compared with the time needed for refueling a gasoline powered vehicle.

In this application, “gasoline powered” is intended to mean combustion engines that may utilize gasoline, diesel fuel, or fuels that include gasoline and/or diesel fuel as a component, such as ethanol and gasoline blended fuels.

Gasoline powered vehicles can be refueled in approximately 10 minutes on average, using conventional gasoline or diesel fuel pumps. By regulation, the maximum fuel flow rate in the United States is limited at 10 gallons (37.9 liters) per minute. Automobiles and pickup trucks have fuel tanks ranging from 10- to 30-gallon capacities, and fuel tanks for semi trucks range in size from 120 to 150 gallons, with many semi trucks having two tanks.

Electric vehicles are charged by direct wire connections from a fixed charging station to a port or adaptor on the electric vehicle. There are three different types of electric vehicle chargers, known as Level 1, Level 2, and Direct Current Fast Charging (DCFC), each with a different charge rate. A Level 1 charger, through a 120-volt AC outlet, may take 40 to 50 hours to charge a battery electric vehicle (BEV) from empty, or 5 to 6 hours to charge a plug-in hybrid electric vehicle (PHEV). A Level 2 charger, through a 240-volt source, may take 4 to 10 hours to charge a BEV or 1 to 2 hours to charge a PHEV. DCFC chargers, primarily compatible with BEV only, can charge a BEV to approximately 80 percent between 20 minutes to an hour. Because of the nature of DCFC charging, as a battery charge exceeds 80 percent, the rate of charge decreases, so it is more efficient to charge a BEV up to around 80 percent at a DCFC charger.

This discrepancy between refueling times for gasoline powered vehicles and charging times for electric vehicles is considered a significant obstacle to the adoption of electric vehicles. Related issues, namely that of the travel range of an electric vehicle and availability of charging stations, are additional obstacles to adoption of electric vehicles.

While some PHEVs provide for charging of the electric power system through the use of a gas-powered engine, thereby extending the range of the PHEV between charges, such systems do not remove the need for refueling the gas tank. Further, current PHEVs have a range of less than 50 miles using the electric power system. BEVs have a range of between 100 to 300 miles per charge.

The foregoing data are provided by the U.S. Department of Transportation.

The convenience of charging an electric vehicle is far less than that for gasoline vehicles.

Current in-place charging stations provide a fixed number of chargers available to vehicles at any given time, and the number of chargers at these charging stations may be comparable to the number of pumps at a gasoline station. However, due to the different length of time required for charging an electric vehicle compared to the time required for fueling a gasoline vehicle, the number of vehicles per hour that can be charged is far fewer than the number of vehicles which can be fueled. The lower number of fixed charging stations compared to the number of gasoline stations compounds the relative inefficiency of charging an electric vehicle compared to fueling a gasoline vehicle.

Third party studies have shown that PHEV usage could significantly reduce the usage of combustion engine power if the driving range of PHEVs could be increased. For long trips, drivers would prefer to reduce the overall time taken from traveling due to stopping to recharge an electric-powered vehicle.

Trips, especially extended trips, in electric-powered vehicles (EVs) are currently limited by several factors: the availability of in-place charging stations; the longer idling time compared to gasoline-powered vehicles needed to “refill”; and the capacity of the EV's battery. Replacing the widespread network of gasoline delivery stations with charging stations will require a significant investment and will take many years to establish. Battery capacity will inevitably improve, but the larger “tank” will necessarily require more time to recharge, so that long lines at charging stations, even if widely available, will likely cause transit delays. Unless charging speeds are dramatically increased, these in-place “stations” will not be able to timely meet user demand.

For commercial vehicles, such as freight trucks, adoption of electric power has been slow, due to the greater power needs of freight trucks, and the need for freight to travel between destinations as efficiently as possible. Estimates of the weight of batteries needed for long haul freight trucks with current charging methods are in the range of a quarter of the truck's carrying capacity. As such, implementing electric power in freight trucks is not yet economically efficient.

Developments in charging electric vehicles while moving include the use of inductive charging. Several states are testing the implementation of incorporating inductive charging within roadways, for use by electric vehicles. The roadway-based inductive charging systems involve embedding coils within or underneath pavement or road surfaces, allowing the transfer of energy to a vehicle-mounted receiver beneath the electric vehicle.

The magnetic fields inherent in roadway-based inductive charging systems presents problems to the general public. For example, some pacemakers may be susceptible to magnetic fields. The implementation of roadway-based inductive charging systems is not likely to have been anticipated by pacemaker manufacturers when they considered shielding and the level of environmental magnetic fields in use. The level of magnetic fields in roadway-based inductive charging systems could pose significant risks toe pacemaker users, who may not have an option to avoid such systems, even if not needed. Also the cost of embedding the coils in the pre-existing roadway and maintenance thereafter may not be cost-effective.

It is desired to provide a more efficient charging system that will reduce the amount of time an electric-powered vehicle will need to stop for charging.

It is desired to provide an electric vehicle charging system that can allow such vehicles to charge while in motion.

### SUMMARY

The invention is a roadway charging system for electric vehicles that provides a source of electricity to vehicles in motion on the roadway. The electricity is preferably provided through a wireless charging system such as electrodynamic wireless charging or resonant inductive coupling, where the energy transfer occurs without a direct connection between the electric vehicle and the power supply.

The wireless charging system comprises an elongated conductor that extends along and parallel to a section of the roadway. The elongated conductor may be located level with the roadway surface or preferably slightly elevated above ground, along the side of the roadway adjacent to or incorporated within a guardrail. The electric vehicle includes a conductor or conductive material that extends from the electric vehicle, toward the elongated conductor.

The method of use involves the steps of: (1) communication between the wireless charging system and the electric vehicle, where the electric vehicle provides identification information to the wireless charging system, (2) the electric vehicle and the charging system arrange for a charging session to commence, (3) the electric vehicle approaches the charging system, (4) the charging system acknowledges and activates the charging session, (5) the charging system provide power to the electric vehicle, and (5) the charging session is terminated.

### BRIEF DESCRIPTION OF THE DRAWINGS

FIG. 1 is a top view of an embodiment of the charging system in operation.

FIG. 2 is a schematic view of the charging system.

FIG. 3 is side view of one embodiment of a charge rail.

FIG. 4 is a side view of an alternate embodiment of a charge rail.

FIG. 5 is a side view of another embodiment of a charge rail.

FIG. 6 is a side view of an alternate embodiment of the charging system above a roadway.

FIG. 7 is a side view of another embodiment of a charge rail.

FIG. 8 is a process view of the charging system.

### DETAILED DESCRIPTION

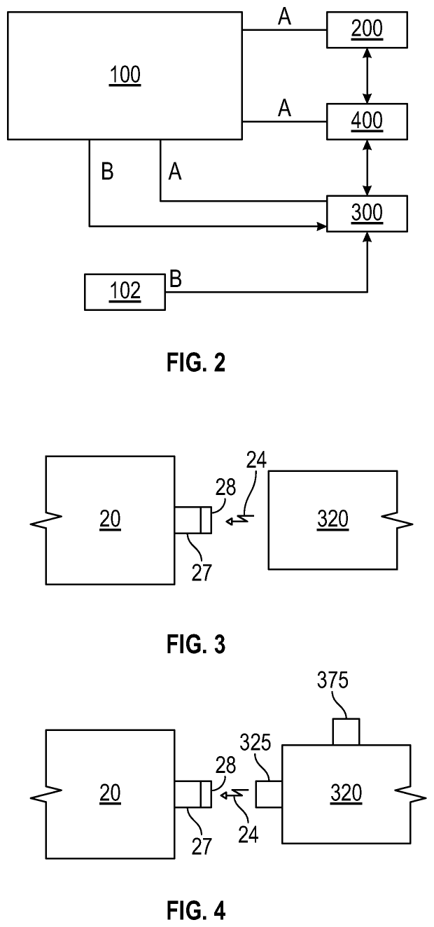

As shown in FIG. 2, the charging system preferably consists of a power supply 100, a communication subsystem 200, a charge distribution subsystem 300, and a data processing subsystem 400.

Power supply 100 supplies operational power (A) to communication subsystem 200, charge distribution subsystem 300, and data processing subsystem 400. Power supply 100 also provides charging power (B) for electric vehicle charging through charge distribution subsystem 300. In an alternate embodiment, a second power supply 102 may be used to provide charging power (B).

Communication subsystem 200 provides for communication between an electric vehicle, data processing subsystem 400, and a remote server 500. As is known in the art, communication subsystem 200 may incorporate satellite and/or cellular telephone communication means, and preferably connects to the Internet.

Data processing subsystem 400 may be implemented by a standard computer or specialized processing device, and controls the local operation of the charging system, including the charge distribution subsystem 300.

Charge distribution subsystem 300 includes charge rail 320 or similar structure to deliver a charge to an electric vehicle. Preferably charge distribution subsystem 300 is placed adjacent to a roadway 1000, more specifically, adjacent to a lane of travel 1100 on roadway 1000. Charge rail 320 may be a single source of electric power, or may be comprised of several power transmitters 325 along charge rail 320.

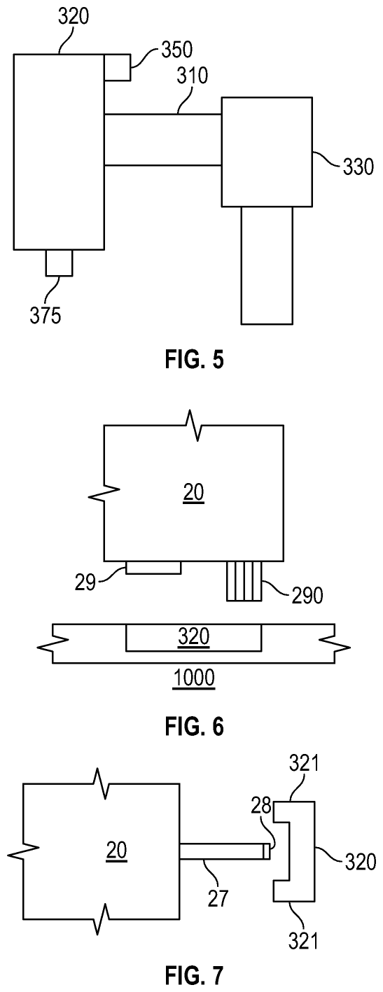

In an alternate embodiment as shown in FIG. 5, charge distribution subsystem 300 includes retractable arm 310 and motor 330, where motor 330 provides for the extension and retraction of retractable arm 310, and charge rail 320 is mounted on retractable arm 310. The extension and retraction of retractable arm 310 allows for charge rail 320 to be located closer to vehicles traveling on the roadway 1000, when needed.

Charge distribution subsystem 300 preferably includes a plurality of sensors 350 for detecting the approach of a vehicle for charging, and the vehicle's position relative to charge rail 320.

Present technology includes the use of an inductive field for the exchange of electric power to an electric vehicle, without requiring a direct wired connection. The system of the disclosure may be used with any charging system that allows for charging an electric vehicle while in motion, even charging methods similar to an electrified rail used for subways and trains.

In one embodiment, the vehicle 20 comprises an extension 27 capable of extending from and retracting into the vehicle. A conductive or reception connector 28 is located at a distal end of the extension 27. The reception connector 28 functions similar to the plate from a subway car that engages an electrified “third” rail. The reception connector 28 would be positioned adjacent to the charge rail 320, close enough to allow for the transfer of electricity from the charge rail 320 to the reception connector 28. The reception connector 28 could be any of a variety of shapes, including a flat plane, a disc, a “U”-shape that overlaps charge rail 320, or a multi-pronged extension.

The distance between the reception connector 28 and charge rail 320 will affect the efficiency of the charging operation, as is known in the art, where the closer reception connector 28 is relative to charge rail 320, the more efficient the charging operation.

In a particular embodiment as shown in FIG. 7, charge rail 320 will comprise two separate plates 321. The reception connector 28 would interpose itself between plates 321 of charge rail 320, and travel between the plates as the vehicle 20 moves relative to charge rail 320. In another embodiment, the connector could be shaped like a ball or wheel and roll along an above-ground channel in or at the charge rail 320.

Regardless of the configuration, the connector 28 and extension 27 would preferably only extend from the vehicle 20 during charging and would otherwise be retracted, in contrast to electrified subway trains where the power connection is fixed in place.

In another embodiment, the charging lane of the roadway would be separated from the main roadway by a guardrail or other divider as is known in the art. Having a divider or guardrail would protect the vehicle being charged from contact with the regular traffic flow. As an essential element of the charging system described herein involves the vehicle maintaining a constant distance from the charge rail, having some protection from the remaining traffic flow, which would prevent the vehicle being charged from having to swerve or otherwise avoid vehicles on the main roadway.

In one embodiment as shown in FIGS. 4 and 5, charge rail 320 will also include proximity beacons 375. The proximity beacons 375 will enable a vehicle equipped with a self-driving function to control its distance from charge rail 320 with greater precision than a human operator.

In yet another embodiment as shown in FIG. 6, the electric vehicle might have specially designed tires 290, with magnetic coils embedded in the grooves, or an underbody receiver 29 attached to the underbody of the electric vehicle, taking the place of connector 28. The driver would charge the electric vehicle by maneuvering the electric vehicle into position over a ground-level charge rail 320. The ground-level charge rail would be situated alongside the roadbed, but otherwise be similar in operation to the roadside charge rail discussed above. The electric vehicle would be driven as usual, while the electric vehicle's tires 290 or the underbody receiver 29 passes over the ground-level charge rail 320. Close proximity to the ground-level charge rail 320 would allow for the transfer of electric energy to the electric vehicle.

An advantage of this embodiment is that the distance between the electric vehicle's tires 290 with embedded coils or the receiving unit 29 and the ground-level charge rail would be fixed and relatively close, without the need for a movable extension. In the case of the tire-embedded coils, the distance from the ground-level channel could be less than two cm, facilitating the efficiency of induction charging. In either case, the charge would flow from the charge rail 320 to the special tires 290 or the receiver 29 and then to the electric vehicle battery. The electric charge could travel through existing or modified cabling on the wheel/axle.

In the embodiment of tire embedded coils, the charging distribution system 300 would be elevated above the roadway and not incorporated within the roadway. Upon approach to the charge system of this embodiment, the vehicle would rise on a slight ramp.

The method of operation for the charging system is described below.

When an operator of a vehicle 20 traveling on the roadway 1000 desires to initiate a charge session, the operator and/or vehicle will initiate communication to communication subsystem 200, requesting access to charge distribution subsystem 300. Upon receipt of a request from a vehicle or its operator, communication subsystem 200 then submits the request to data processing subsystem 400, which will then start a charge session on charging subsystem 300. A remote server 500 may also be part of the access communication as discussed below.

The initial communication from vehicle 20 will indicate the vehicle's position, type of vehicle and other relevant vehicle characteristics to communication subsystem 200. Preferably, this initial communication will also include identifying account information to enable billing for the charging session. The vehicle characteristics preferably include identification of the vehicle's charging type, so that the data processing system 400 can evaluate whether the charging subsystem 300 is able to charge the vehicle, or if another charging system would be recommended.

Upon receipt of the information from communication subsystem 200, data processing system 400 will confirm the availability of charging distribution subsystem 300. The availability of charge distribution subsystem 300 will be affected by whether another vehicle may have already initiated a charging session, and whether the charging subsystem is capable of providing a charge to the vehicle.

In the event that charge distribution subsystem 300 is occupied or otherwise unavailable, a message will be returned through communication subsystem 200 to the operator and/or vehicle.

Where a charging session is available and suitable for the approaching vehicle, data processing system 400 will direct the charge distribution subsystem 300 to begin to prepare for the charging session. These steps involved in preparing for a charging session will include activating the induction field so that a charging session can occur. Preferably the charging session will not start until the vehicle is at or about to approach the charging rail so as to minimize energy loss. Where charging subsystem 300 includes a retractable arm embodiment, the preparation may also include extending the retractable arm 310 and charge rail 320 to place those in proximity to the approaching vehicle

Users of either version—the direct connection or the wireless—would pay based on the duration of attachment and the speed or level of charging, priced accordingly. It is anticipated that each separate charge distribution system 300 would be between one and five kilometers in length, and that charging systems may be located every 20-30 kilometers.

The charging system could be energized from the existing power grid or could utilize a dedicated energy source, such as a wind turbine or solar panels, combined with a power storage.

The method of the system described herein involves the following steps. First, an initial communication is made between the vehicle and the charge system. The initial communication would include vehicle identification information such as type of vehicle, type of battery involved, the vehicle's requirements for charging, account information, vehicle location, and vehicle current charge level. Upon receipt of the communication, the charge system would verify the account and vehicle information, confirm that it is able to initiate a charge session, confirm that the charging system is available for use, and based upon the vehicles location, would begin preparation of the charging subsystem to start a charging session.

In one embodiment, the vehicle will extend a connector 27, or other means for receiving the inductive charge from the charging distribution subsystem 300. The connector would be extended at or prior to the vehicle's initial approach to the charge distribution subsystem.

Once the vehicle connector 27 is engaged with and proximate to the charge rail 320, a charge would commence as the vehicle 20 is traveling along the charge rail 320. The charge distribution subsystem 300 would pass information to data processing system 400 confirming the charge session's start time, the amount of charge being transmitted to the vehicle, and upon termination of the charge session, the termination time so that the value of the charge session may be calculated.

Where the vehicle 20 includes an autopilot, driverless navigation and/or self-driving feature, in an alternate embodiment the charge system may interact with such self-driving feature of the vehicle, facilitating control of the vehicle's distance from the charge rail 320, thereby making the charge transfer more efficient. The vehicle autopilot may include the ability to detect proximity beacons 375 on charge rail 320.

The charging system would be centrally controlled and accessed through a mobile or web-based app. A central server 500 would store all relevant user and vehicle data including past charging history (frequency, charge locations, amount of charge, time to charge, odometer reading, billing information). The central server 500 will, on demand from a user device or vehicle 20, verify nearby charging availability within the system network. When a user accesses the charging system through a mobile app or on-board display screen, member confirmation, percent battery charged, location of electric vehicle and intended electric vehicle route and ETA will be communicated to the central server 500. In turn, the system will then assess available charging systems 300 within a designated radius or along a desired route, evaluate expected length of charging connection and authorize (52) an “appointment” which will be communicated to the user or vehicle 20 through the same mobile app or on-board screen.

The charging system could also include a windshield- or dashboard-affixed transponder 700 similar to EZ-Pass or other automated toll systems. Upon arrival at a designated charging system, the transponder 700 will engage with communication system 200 to contact the central server 500, requesting authorizing (52) for the electric vehicle's connection to the charge distribution subsystem 300. The transponder 700 will also confirm the vehicle's subsequent detachment from the charge distribution subsystem 300, and may communicate the percent battery charge at disconnection, or amount of charge received during the charging session.

Where the vehicle and charging system may also communicate information regarding the vehicle's planned destination, the charging system may also provide the user with notice of prospective charge status at the planned destination and may also suggest other charging systems near the intended destination that the user might consider.

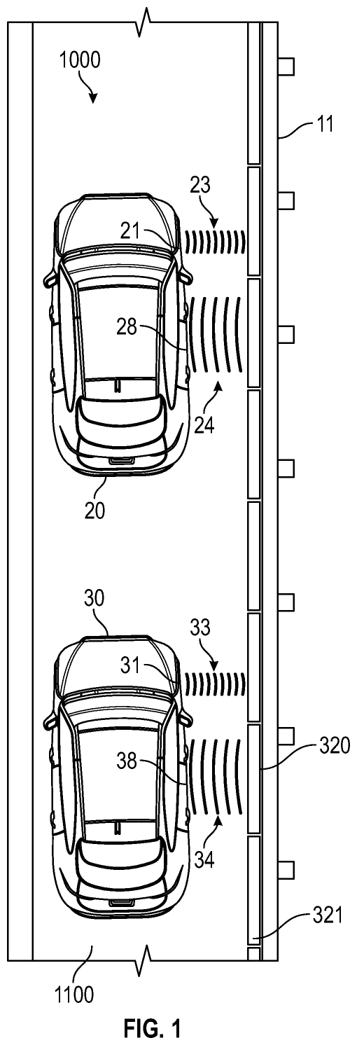

In FIG. 1, an example instance of the system is described, where two vehicles 20, 30 are traveling on a road 1000 while simultaneously being wirelessly charged. Along the side of the road 1000 is charge rail 320 or similar type structure. Charge rail 320 may also include a series of power transmitters 325 and proximity beacons 375. These may be located in a variety of positions relative to the charge rail 320 or conventional roadside guardrail.

Vehicle 20 communicates with the charging system through an internal transmitter 21 that the vehicle 20 requires charging. The signal 23 transmitted by the vehicle's internal transmitter 21 is received by communication system 200, which performs the functions of (a) locating the vehicle 20 and (b) validating the vehicle's charging access via central server 500. If the central server 500 approves of the vehicle charging, the charge rail 320 nearest to the vehicle will be activated to transmit power to vehicle connector 28. As the vehicle 20 travels near charge rail 320, the active power transmitter 325 and proximity beacons 375 will change.

The account information will confirm whether the account associated with the vehicle is funded or otherwise in good standing.

Simultaneous to the charging of the vehicle 20 described, additional vehicles may be charged by the charging system. FIG. 1 shows a second vehicle 30, containing its own internal transmitter 31 and connector 38. This second vehicle 30 interfaces with the charge rail 320 in a similar manner as vehicle 20.

Any vehicle may travel along charge rail 320 without receiving an energy transfer, simply by not sending a charging request to the system. Further, in a similar manner where the system denies access even if a request is transmitted from the vehicle 20, energy transfer is not provided to the vehicle.

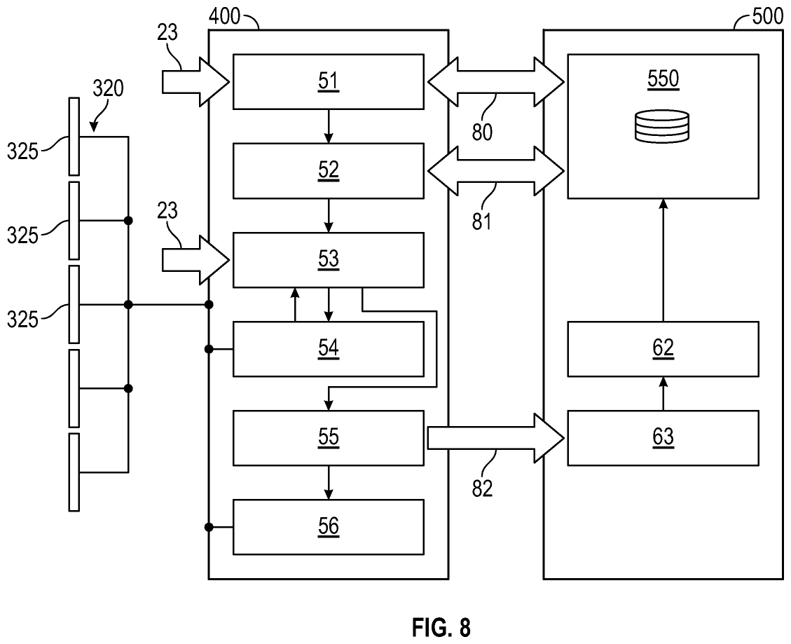

Referring to FIG. 8, the high-level operation of the charging system is shown. A charge distribution subsystem 300 is directly connected to data processor 400. Data processor 400 communicates with a central server 500 for the charging system. A vehicle's initial request for charging 70 triggers data processor 400 to authenticate (51) the user's account within a database 550 of the central server 500. The data processor 400 will then check (80) the authorization of the user's account though central server 500 to permit charging. If authorized (52), the local controller will begin to a vehicle tracking 53 subroutine, which consists of receiving the repeated charging requests 23 from the vehicle 20 though the charging system 300. With a proper location fix on the vehicle 20, the data processor 400 will transmit energize the proper charge rail 320 via power transmit control signal 54. Once a vehicle leaves the charge distribution subsystem 300, or ceases to request charging, the charging requests 23 will cease, indicating to the data processor 400 that the vehicle 20 has disconnected (55) from the system, and disable the power transmission (56). The disconnection triggers a communication 82 to the central server 500 which will cause the central server to calculate (63) the total amount of charge provided to the vehicle 20 and will add (62) the monetary charge to the user's account.

It should be understood that the process as described herein may vary in certain aspects, depending on the account setup.

Alternatively, connection to the charging system could also be on a “drive-in” basis for non-members via another affiliated entity's transponder (e.g., EZ-Pass) or via direct access from a mobile app. In the latter option, GPS or similar features of the mobile app would be available to non-members which would identify the nearest available charging system and estimate the time needed to be re-charged (at super, high and regular speeds). An appointment could be initiated and authorized upon arrival at the charging system automatically via EZ-Pass or voice-initiated and authorized through the electric vehicle's on-board central processing unit which would have determined whether and how soon a re-charge is needed as part of the mobile app protocol.

If accessing via the affiliate system, for example EZ-Pass, the connection would automate both the appointment details and payment for the re-charge through the electric vehicle's dashboard/windshield transponder. EZ-Pass, for example, would credit the charging system by their tag holder for the cost of the kilowatt-hours (kW h) used and speed of re-charge. The data from the “drive-in” connection would, as in the member set-up via the mobile app, be transmitted to the central system and copied to a temporary account history for the unique electric vehicle. This information would be retained indefinitely and eventually merged into a formalized member account for the electric vehicle if the electric vehicle owner decided to become a member.

While certain novel features of the present invention have been shown and described, it will be understood that various omissions, substitutions and changes in the forms and details of the device illustrated and in its operation can be made by those skilled in the art without departing from the spirit of the invention.

I claim:

1. An electric vehicle charging system comprising:
a power supply;
a communication system;
a data processor;
a charging subsystem, the charging subsystem comprising a charge rail, capable of delivering a charge to an electric vehicle.

2. The charging system of claim 1, where the charge rail is located adjacent to a roadway, and extends along the roadway.

3. The charging system of claim 2, further comprising:
a plurality of sensors along the charge rail.

4. The charging system of claim 2, further comprising:
A retractable arm, on which the charge rail is mounted; and
a motor capable of extending and retracting the retractable arm.

5. The charging system of claim 1, further comprising:
a second communication means for communicating directly with a self-driving feature of the electric vehicles.

6. The charging system of claim 1, where the charge rail is located above the surface of a roadway, and extends along the roadway.

7. The charging system of claim 1, further comprising:
a remote database containing user access information, the remote database in communication with the data processor.

8. A method for charging electric vehicles, the method comprising the steps of:
receiving a request for charging from a vehicle;
determining the availability of a charging subsystem;
responding to the request for charging;
detecting the approach of an oncoming vehicle;
instructing a charge subsystem to begin charge session;
detecting the termination of the charging session; and
instructing the charge subsystem to revert to an inert status.

9. The method of claim 8, further comprising the steps of:
identifying whether the vehicle has a self-driving system;
initiating communication with the vehicle's self-driving system;
providing control signals to the vehicle's self-driving system as the vehicle travels along the charging subsystem; and
releasing the vehicle from control at the end of the charging session.

10. The method of claim 8, further comprising the steps of:
accessing a remote database to verify an account for access to the charging subsystem.

11. The method of claim 8, further comprising the steps of:
sending a warning signal to the vehicle prior to the termination of the charging session.

12. The method of claim 8, further comprising the steps of:
sending a warning signal to the vehicle prior to release of control of the vehicle.
